(19) United States
(12) Patent Application Publication
(10) Pub. No.: US 2011/0168469 A1
(43) Pub. Date: Jul. 14, 2011

(54) TORQUE-FILL DURING GEAR CHANGE ON MANUAL TRANSMISSIONS WITH HYBRID VEHICLES AND VEHICLES WITH DUAL PROPULSION SOURCES

(75) Inventor: Mattias HANSSON, Goeteborg (SE)

(73) Assignee: GM GLOBAL TECHNOLOGY OPERATIONS LLC, Detroit, MI (US)

(21) Appl. No.: 12/968,093

(22) Filed: Dec. 14, 2010

(30) Foreign Application Priority Data
Dec. 14, 2009 (GB) 0921775.3

(51) Int. Cl. B60K 6/20; B60K 6/38

(52) U.S. Cl. 180/65.275; 180/65.21; 903/902

(57) ABSTRACT

A vehicle is provided that includes, but is not limited to wheels, a first propulsion source, a second propulsion source, and an interface device. The first propulsion source is connected to at least one wheel via a clutch and it intended for providing a first torque to the wheel. The clutch is intended to selectively remove the first torque from the wheel during the time of a gear change by disengaging the first propulsion source from at least one wheel. The second propulsion source is connected to the wheel. The interface device is used for controlling a provision of a second torque from the second propulsion source to at least one wheel during the gear change.

### CROSS-REFERENCE TO RELATED APPLICATION

This application claims priority to British Patent Application No. 0921775.3, filed Dec. 14, 2009, which is incorporated herein by reference in its entirety.

### TECHNICAL FIELD

A dual propulsion vehicle includes an engine that consumes a fuel in an engine-running mode and an electric motor that consumes electric power in a motor running mode.

### BACKGROUND

A dual propulsion vehicle does not emit pollution when running in the motor running mode whilst the engine compensates or avoids disadvantages of the motor. The disadvantages include a long period for charging a battery for providing electrical power to the motor whilst the battery usually allows the motor to function for only a relatively short time. The arrangement of the vehicle can provide better fuel consumption efficiency.

Accordingly, it is at least one object to achieve smoother gear change for hybrid vehicles and vehicles with dual propulsion sources. The vehicles provide a means of transportation whilst the propulsion sources provide torques for turning wheels of the vehicle. In addition, other objects, desirable features and characteristics will become apparent from the subsequent summary and detailed description, and the appended claims, taken in conjunction with the accompanying drawings and this background.

### SUMMARY

The vehicles can have manual transmission, semi-automatic transmission (MTA), or automatic transmission. The transmission is also called a gearbox. The transmission has gearwheels that can be arranged to provide different gearwheel ratios. The different gearwheel ratios allow the transmission to expand output rotation speed ranges for corresponding input torque ranges. The gearwheel ratio is changed during a gear change.

One thought of the application is that a vehicle that shifts or changes gear without a break of torque would achieve a higher comfort and acceleration. Engine torque that is interrupted during a gear change can be filled or be compensated by an electric motor torque. Therefore, a first method and a second method are provided for providing a torque to wheels of a vehicle. The first method provides the torque to the same wheels whilst the second method provides torque to the different wheels of the vehicle.

Referring to the first method, the first method comprises a step of providing a first torque from a first propulsion source to one or more wheels through a clutch. The first torque is later removed from the wheels during the time of a gear change using the clutch to disengage the first propulsion source from the wheels. The wheels thus experience a void of the first torque. The gear change relates to a change of gear ratio of a transmission of the vehicle.

A second torque to the wheels is then indicated using a pedal during time of the gear change. A driver of the vehicle can use the pedal to provide this indication. The second torque from a second propulsion source is afterward applied to the wheels in accordance to the indication. In effect, the second torque fills the first torque void during the gear change. This filling of torque provides the advantage of providing a more comfortable drive for passengers of the vehicle. The vehicle can also has a better fuel efficiency.

Referring to the second method, the second method comprises a step of providing a first torque from a first propulsion source to one or more first wheels. The first torque is then removed to the first wheels using a clutch during a gear change. A second torque to one or more second wheel is later indicated using a pedal during the gear change. The second torque is afterward applied from a second propulsion source to the second wheels during the gear change.

The first and second methods provide different ways of applying torque to the wheels of the vehicle. Referring to the first and the second methods, an amount of the second torque for applying during the gear change can be determined or controlled using position information of a clutch pedal. The clutch pedal controls an engagement between the transmission and the first propulsion source. The position information of the clutch pedal indicates whether the first propulsion source is engaged or is disengaged from the transmission. Further, the determination of the second torque can also include using of position information of next gear. The next gear can refer to a higher gear or to a low gear. The gear relates to a gear ratio of the transmission.

The engine speed also can be changed or regulated during the gear change. The regulation can use position information of the acceleration pedal. The acceleration position can indicate that a driver of the vehicle desires a higher, a lower vehicle, or a constant vehicle. In another aspect of the application, the regulation also uses position information of the clutch pedal or uses position information of next gear.

A first and a second vehicle are also provided in accordance with embodiments of the invention. The first and second vehicles each have dual propulsion sources and one or more wheels. The dual propulsion sources of the first vehicle drive the same wheels of the vehicle whilst the dual propulsion sources of the second vehicle drive the different wheels.

Referring to the first vehicle, the first vehicle includes the plurality of wheels, the first propulsion source, the second propulsion source, and an interface device. The first propulsion source is connected to one or more wheels via a clutch. The first propulsion source is used for providing a first torque to one or more wheels. The clutch is intended for selectively removing the first torque from the wheels during a gear change by disengaging the first propulsion source from the wheels. The disengaging allows changing to a next gearwheel ratio.

Likewise, the second propulsion source is connected to one or more wheels. The second propulsion source provides a second torque to the wheels during the time of the gear change in accordance to a control of the interface device. A driver of the vehicle can use the interface device to control the second torque to fill the break of the first torque during the gear change.

Referring to the second vehicle, the second vehicle comprises the plurality of wheels, the first propulsion source, the second propulsion source, and the interface device. Similarly, the first propulsion source is connected to one or more first wheels via a clutch. The first propulsion source is intended for providing a first torque to the first wheels whilst the clutch is intended for selectively removing the first torque from the first wheels during a gear change by disengaging the first propulsion source from the first wheels. The second propulsion source is connected to one or more second wheels whilst the interface device controls a provision of a second torque from the second propulsion source to the second wheels during the gear change.

The first and second vehicles have an advantage of avoiding the torque break during the gear change and thus providing a more comfortable ride for passengers of the vehicle. The vehicles can use a manual, semi-automatic, or automatic transmission. The first and second vehicles have an advantage of providing a more comfortable ride for passengers of the vehicle since the torque break during the gear change is avoided.

Referring to the first and the second vehicles, the interface device can include a pedal. A position of the pedal is used for indicating or controlling an amount of the second torque to provide or to apply to the wheels during the gear change. A driver of the vehicle can use the pedal to control the provision of the second torque to the wheels. In most cases, the pedal refers to an accelerator pedal that provides the said function. In a generic sense, the pedal can also refer to push buttons that are mounted to a steering wheel of the vehicle, or to a paddle shifter for selecting an up-shift or a down-shift of gears. Further, the interface device may include a clutch pedal. The clutch pedal selectively activates the clutch to disengage the first propulsion source to the wheel.

The first propulsion source can comprise an internal combustion engine whilst the second propulsion source can comprise an electric motor that is charged by an accumulator. The combustion engine converts a fuel, such as diesel or petrol, into rotational energy whilst the electric motor converts electrical energy into rotational energy. For adapting power and speed of the second propulsion source, the second propulsion source can be connected to the wheel via a mechanical reduction. Further, the vehicle can include a transmission that is connected to the wheels and that is engaged to the first propulsion source via the clutch. In other words, the transmission selectively transmits the torque of the first propulsion source to the wheels.

To drive the wheels, the transmission can include a final drive that is connected to the wheels. The final drive refers to a relatively large gearwheel. The final drive can include a ring gear. The second propulsion source can be connected directly to the final drive or be connected to final drive by a clog wheel. Put differently, the final drive can receive torque from either the first or second propulsion source for transmitting to the wheels. The transmission is usually connected to the wheels via a differential gear box. The differential gear box allows the different wheels to rotate at different speeds. The wheels have different speeds when the vehicle moves around a corner.

A second propulsion source is provided for a vehicle. The vehicle includes a plurality of wheels and a first propulsion source that is connected to one or more of the wheels via a clutch. The first propulsion source is intended for providing a first torque to the wheel whilst the clutch is intended for selectively removing the first torque from the wheels during a gear change. The removal is by means of disengaging the first propulsion source from the wheels. The second propulsion source is connected to one or more of the wheels and is intended for providing a second torque to the wheels during the gear change in accordance to a control of an interface device.

An interface device is provided for a vehicle. The vehicle includes a plurality of wheels, a first propulsion source, and a second propulsion source. The first propulsion source is connected to one or more wheels via a clutch. The first propulsion source is intended for providing a first torque to the wheels whilst the clutch is intended for selectively removing the first torque from the wheels during a gear change. The removal is by disengaging the first propulsion source from the wheels. The second propulsion source is connected the wheels. The interface device is intended for controlling a provision of a second torque from the second propulsion source to the wheels during the gear change.

### BRIEF DESCRIPTION OF THE DRAWINGS

The present invention will hereinafter be described in conjunction with the following drawing figures, wherein like numerals denote like elements, and:

FIG. 1 illustrates a block diagram of a first embodiment of a dual propulsion source vehicle;

FIG. 2 illustrates a graph of providing torque during changing of gears for the vehicle of FIG. 1;

FIG. 3 illustrates a flow chart of steps of providing the torque of FIG. 2;

FIG. 4 illustrates a block diagram of a second embodiment of the dual propulsion source vehicle;

FIG. 5 illustrates a block diagram of a third embodiment of the dual propulsion source vehicle;

FIG. 6 illustrates a block diagram of a fourth embodiment of the dual propulsion source vehicle;

FIG. 7 illustrates a block diagram of a fifth embodiment of the dual propulsion source vehicle; and

FIG. 8 illustrates a block diagram of a sixth embodiment of the dual propulsion source vehicle.

### DETAILED DESCRIPTION

The following detailed description is merely exemplary in nature and is not intended to limit application and uses. Furthermore, there is no intention to be bound by any theory presented in the preceding background or summary or the following detailed description.

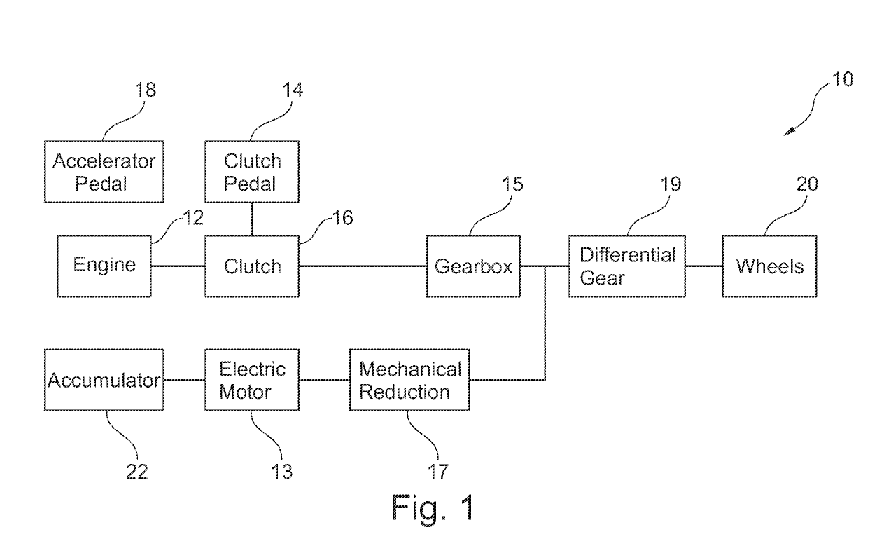

FIG. 1 shows a block diagram of a dual propulsion source vehicle 10. The vehicle 10 includes a combustion engine 12 and an electric motor 13. The combustion engine 12 is connected to a gearbox 15 via an engageable clutch 16 whilst the electric motor 13 is connected to the gearbox 15 and to a differential gear 19 via a mechanical reduction 17. The gearbox 15 is also known as a transmission. A clutch pedal 14 is connected to the clutch 16 whilst an accelerator pedal 18 is connected to the engine 12. The gearbox 15 is connected to the differential gear 19 that is connected to wheels 20 whilst the electric motor 13 is connected to an accumulator 22. The accumulator 22 is also called an energy storage unit.

Functionally, the electric motor 13 and the combustion engine 12 each act as a propulsion source for the vehicle 10. The clutch pedal 14 activates or controls the clutch 16 whilst the accelerator pedal 18 activates or controls an engine speed of the combustion engine 12 via a vehicle control module. This vehicle control module is not illustrated in the figure. The clutch 16 selectively engages the combustion engine 12 to the gearbox 15. The combustion engine 12 converts a fuel, such as petrol or diesel, into a torque that is for transmitting to the gearbox 15 via the clutches 16. The accumulator 22 charges the electric motor 13 such that the electric motor 13 can provide a torque via the mechanical reduction 17 and via the differential gear 19 to the wheels 20. The mechanical reduction 17 allows the electric motor 13 to have a torque that is lower and to have a speed that is higher than those provided by the combustion engine 12.

The gearbox 15 receives the torque from the combustion engine 12 or from the electric motor 13 and it conveys the received torque to the wheels 20 via the differential gear 19. The gearbox 15 provides several gear ratios for conveying the torque to the wheels 20. The differential gear 19 allows the different wheels 20 to turn at different rates when going round a corner. In a special case, the electric motor 13 also acts as a generator that receives a torque from the gearbox 15 and that converts the received torque to an electrical power to charge the accumulator 22. In a generic sense, other type of propulsion source can be provided for the vehicle 10. In a special case, the vehicle 10 does not include the mechanical reduction 17. The gearbox 15 can refer to a manual transmission, to a semi-automatic transmission (MTA), or to an automatic transmission. The MTA is also called an automatic shift gearbox (ASG). The automatic transmission can relate to a Dual Clutch Transmission (DCT).

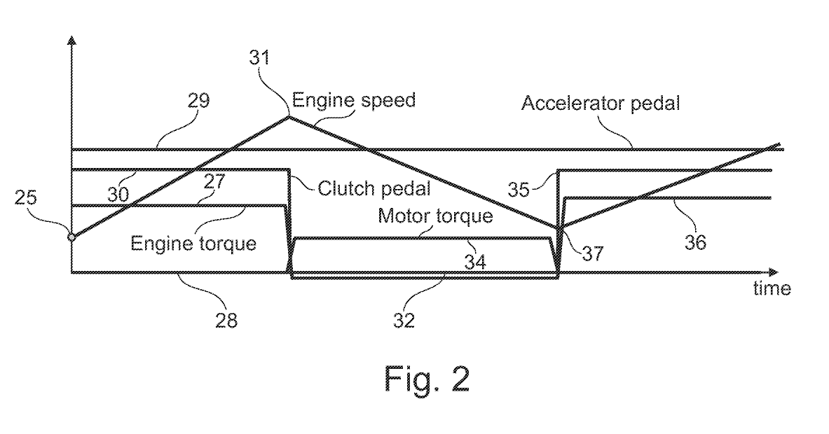

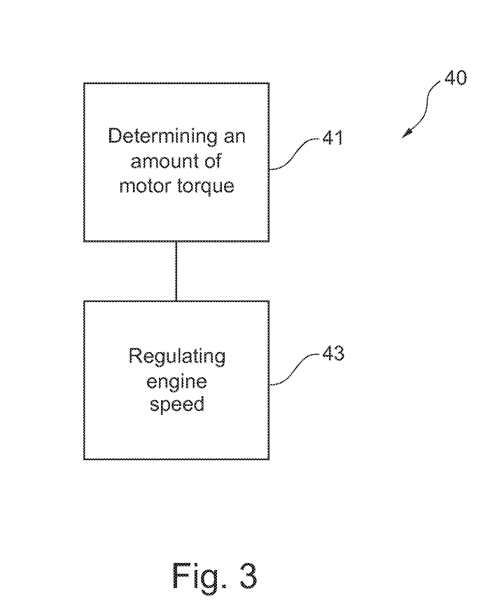

FIG. 2 shows graphs of providing a torque for the vehicle 10 of FIG. 1 whilst FIG. 3 shows a flows chart 40 if providing the torque. The torque allows a driver to move the vehicle 10. The vehicle 10 is initially in a standstill. The electric motor 13 and the engine 12 are both not engaged with the transmission 15.

The driver then steps or presses the accelerator pedal 18 to position the accelerator pedal 18 at a position 29, as illustrated in FIG. 2. This causes a rotating speed of the combustion engine 12 to accelerate to a speed 25, as illustrated in FIG. 2. At about the same time, the driver sets or switches the transmission 15 to a first gear ratio. Later, the driver engages the combustion engine 12 to the transmission 15 via releasing the clutch pedal 14 to a position 30, as illustrated in FIG. 2. The engagement allows the engine 12 to transmit an amount 27 of torque to the wheels 20 whilst the motor 13 provides a zero torque 28 or no torque to the wheels 20. Afterward, when the engine reaches speed 31, the driver afterward changes or shifts gear. In a case that is illustrated in FIG. 2, the driver wants to maintain or to provide the torque to the wheels 20 during the gear change. The driver then uses one foot to press the clutch pedal 14 to a position 32 while using the other foot to continue to keep the accelerator pedal 18 at the position 29.

The accelerator pedal 18 stays in the same position 29 before the change of gear as well as during the change of gear. The same position 29 acts to avoid unexpected acceleration or deceleration, which can occur if the driver has difficulty re-positioning the accelerator pedal 18 again after a release of the accelerator pedal 18. The pressed clutch pedal 14 disconnects the engine 12 from the transmission 15 to allow the transmission 15 to change to the next gear ratio. The disconnection also breaks or removes the engine torque 27 from the wheels 20. The engine speed is then regulated or is changed for engaging the next gear ratio, as illustrated in a step 43 of FIG. 3. The engine speed regulation is in accordance with the position of the accelerator pedal 18 and with the next gear ratio by a vehicle control module. In this case, the next gear ratio refers to a second gear ratio.

Then, an amount of a torque 34 is determined using the position 29 of the accelerator pedal 18 by the vehicle control module, as illustrated in a step 41 of FIG. 3. The electric motor 13 then engages the transmission 15 for providing the torque 34 to the wheels 20. The motor torque 34 acts to fill the break of the engine torque such that the wheels 20 experience the desired or close to the desired torque. In other words, the motor torque 34 fills in the engine torque break using the accelerator pedal position 29. The step has the advantage of removing certain discomfort of the engine torque break during gear shifting. In addition, engine acceleration can be kept positive during the gear change.

Later, at speed 37, the clutch pedal 14 is released to a position 35 to connect the engine 12 to the transmission 15, thereby completing the change of gear. This enables the engine 12 to provide an amount 36 of torque to the wheels 20 whilst the motor torque 34 is removed, as illustrated in FIG. 2.

In a generic sense, this method of providing torque can be applied to two-wheel drive or to four-wheel drive vehicles. The vehicles have dual propulsion sources. The determination of the torque 34 can also include using the clutch pedal position as well as the next gear ratio. The engine speed regulation can also include using the clutch pedal position.

The driver can use the accelerator pedal 18 to indicate a desired engine speed that is higher or lower after the gear change than before the gear change. The driver can also use the accelerator pedal 18 to indicate an idle engine speed after the gear change. Further, the driver can shift or change to a next gear ratio that is higher or that is lower.

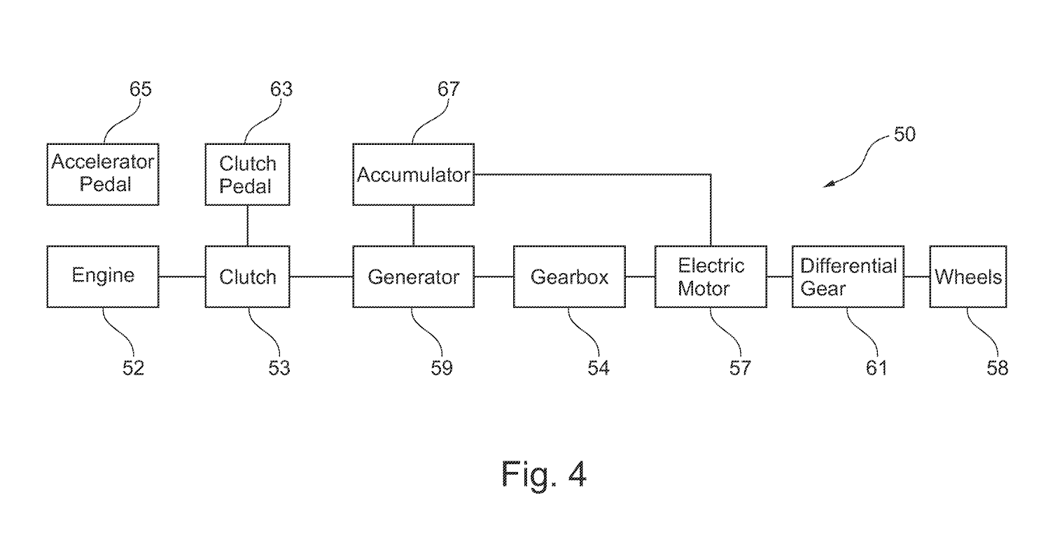

FIG. 4 shows a block diagram of a second dual propulsion source vehicle 50. The vehicle 50 includes a combustion engine 52 that is connected via a clutch 53 to a gearbox 54. The gearbox 54 is connected via an electric motor 57 to wheels 58. The clutch 53 is connected to the gearbox 54 through a generator 59 whilst the electric motor 57 is connected to the wheels 58 through a differential gear 61. A clutch pedal 63 is connected to the clutch 53 whilst an accelerator pedal 65 is provided for controlling the engine 52 and the motor 57. An accumulator 67 is electrically connected to the generator 59 and to electric motor 57. The generator 59 converts rotational movement of the engine 52 to electrical power that is stored by the accumulator 67. The accumulator 67 provides electrical power to the motor 57. The gearbox 54 includes planetary gears for providing different gear ratios. In a generic sense, the vehicle 50 can include one or more motors 57. The motors 57 can have a gear-set for providing torques to the wheels 58. The electric motor 57 can relate to wheel motor that is incorporated into a hub of a wheel and that drives the wheel directly.

The electric motor 57 and the engine 52 can provide torque to the wheels 58 together at the same time or separately at different periods. The electric motor 57 and the engine 52 can be connected to different wheels or to same wheels of the vehicle 50. In one example, the engine 52 is connected to front wheels whilst the electric motor 57 is connected to rear wheels of the vehicle 50. The vehicle 50 provides another embodiment for using the method of providing torque during gear change of FIG. 2 and FIG. 3.

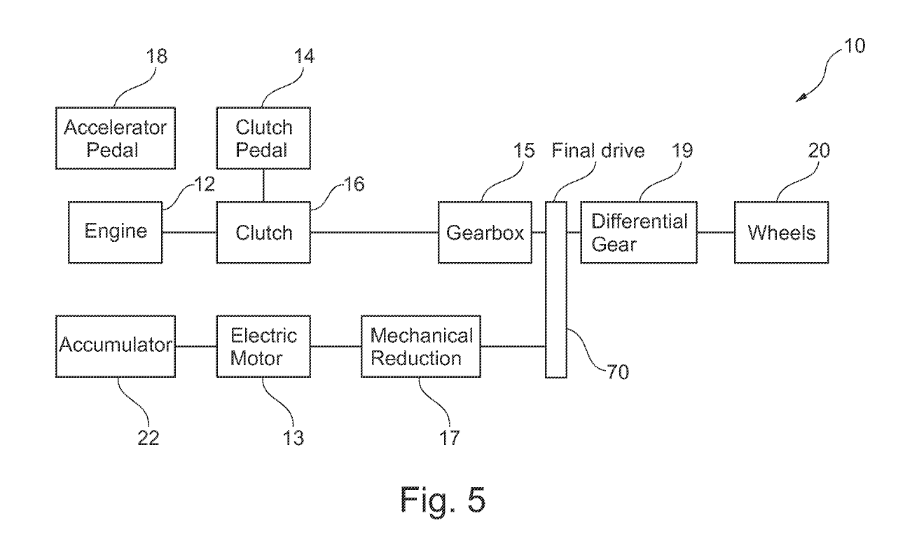

FIG. 5 to FIG. 8 shows block diagrams of different embodiments of the dual propulsion source vehicle 10 of FIG. 1. The different embodiments use the method of providing torque during gear change of FIG. 2 and FIG. 3. The different embodiments show examples of implementing the embodiment of FIG. 1, FIG. 5 to FIG. 8 have parts and structures that are similar to the parts and structures of FIG. 1. The similar part and structure are hereby incorporated by reference.

FIG. 5 shows a first example of implementing the dual propulsion source vehicle 10 of FIG. 1. In this example, the electric motor 13 is connected to a final drive 70 via the mechanical reduction 17. The gearbox 15 is also connected to the final drive 70 whilst the final drive 70 is connected to the differential gear 19. The final drive 70 is also called a final drive pinion. The final drive 70 has teeth for engaging the differential gear 19. In a generic sense, the electric motor 13 is connected to wheel side of the selectable gears of the transmission. The mechanical reduction 17 can be removed such that the electric motor 13 directly engages the final drive 70. Alternatively, the electric motor 13 can also directly engage a cogwheel that is permanently connected to the final drive 70. The final drive 70 can be in the form of a ring gear.

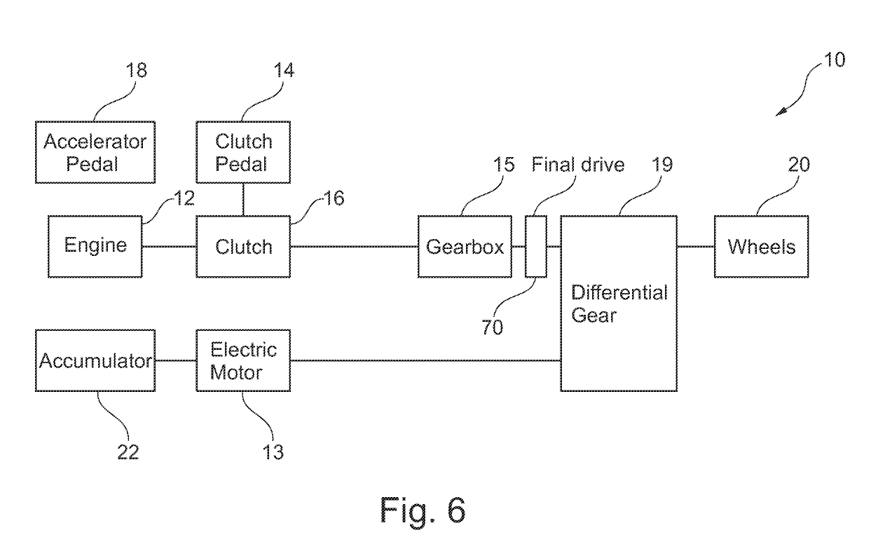

FIG. 6 shows a second example of implementing the dual propulsion source vehicle 10 of FIG. 1. In this example, the electric motor 13 is connected in parallel with the final drive 70 to the differential gear 19.

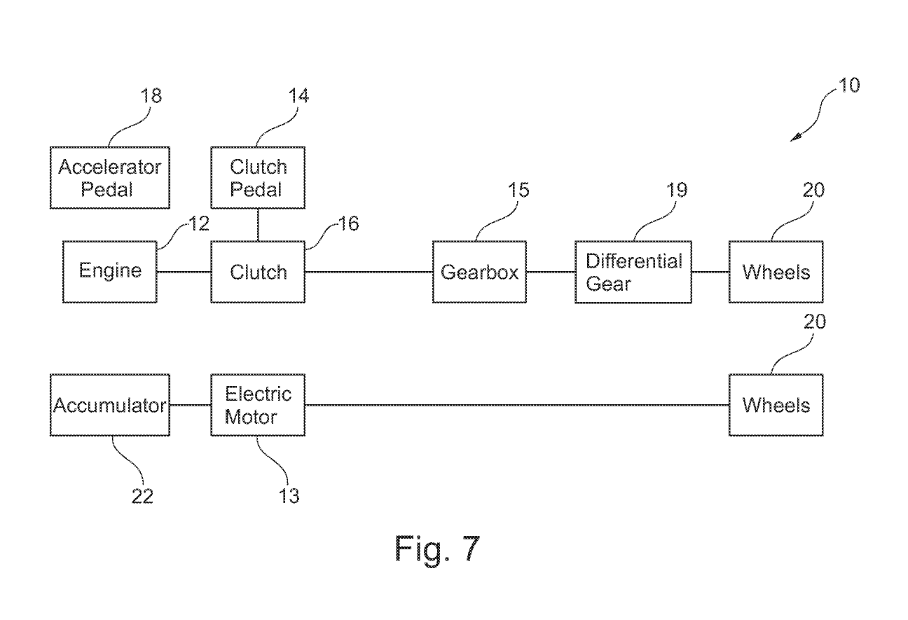

FIG. 7 shows a third example of implementing the dual propulsion source vehicle 10 of FIG. 1. In this example, the electric motor 13 is connected to the wheels 20 that are not propelled by the combustion engine 12. The combustion engine 12 is connected to other wheels 20.

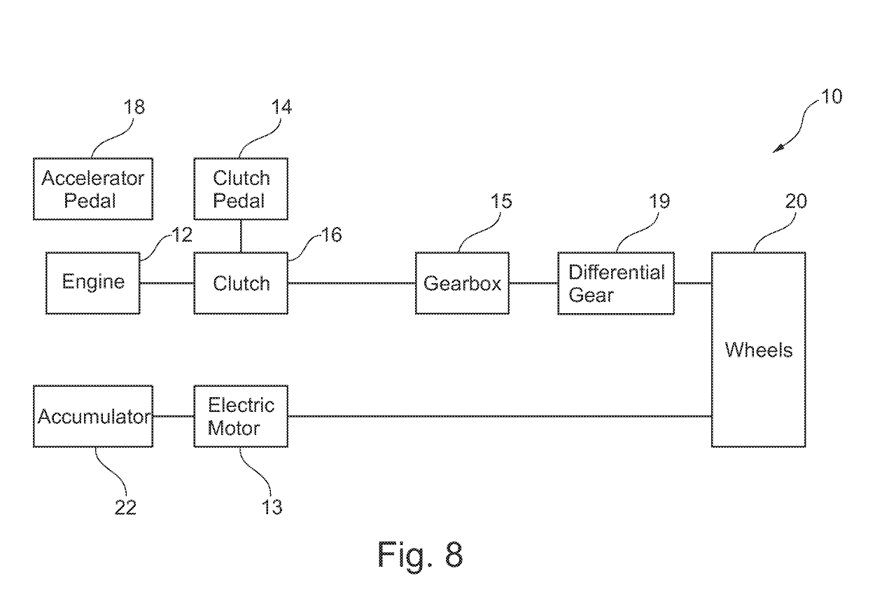

FIG. 8 shows a fourth example of implementing the dual propulsion source vehicle 10 of FIG. 1. In this example, the wheels 20 can be propelled by the electric motor 13 and by the engine 12.

In summary, control is provided for the electric motor and engine speed during gear shift, with a manual transmission. It is possible and may be beneficial to use electric motor torque during gear shifts with MTA, DCT or even conventional automatic, but that is most likely not anything unique about that. In short, the embodiments control speed of the engine 12 and of the motor 13 of manual transmission during shifting of gears. The embodiment can be beneficial during shifting of gears for MTA, DCT, and automatic transmission. Put differently, the embodiment provides a way of engine speed control during the change of gear. Systems or vehicles 10 and 50 shown in the above embodiments support the control. The systems 10 and 50 have an electric motor 13 and 57 respectively and a sensor that detects an oncoming gear position, such as a transmission input gear-speed ratio sensor. The way of speed control includes the step of the driver keeping the foot on the same accelerator pedal position during changing of gears. The sensor, rather than the driver, indicates which speed the engine 12 or 52 should target. The electric motor 13 or 57 provides torque according to driver demand as determined from the accelerator pedal position. When the clutch pedal 14 or 63 is released and the clutch 16 or 53 begins to transmit engine torque, the electric motor torque is reduced.

This is different from other ways of controlling engine speed where the driver control torque to the wheels for the oncoming gear just via the accelerator pedal. For example, for a third to fourth gear ratio shift during acceleration, the driver would release the accelerator pedal to lower the engine speed during the change of gear when the clutch pedal is pressed. If the driver were to keep or maintain the same accelerator pedal position, the engine speed would rise and thus causing a terrible or unpleasant shift.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A vehicle comprising
a plurality of wheels;
a clutch;
a first propulsion source connected to at least one wheel of the plurality of wheels via the clutch, the first propulsion source adapted to provide a first torque to the at least one wheel, the clutch adapted to selectively remove the first torque from the at least one wheel during a gear change by disengaging the first propulsion source from the at least one wheel;
a second propulsion source connected to the at least one wheel; and
an interface device adapted to control a provision of a second torque from the second propulsion source to the at least one wheel during the gear change.

2. The vehicle of claim 1, wherein the interface device comprises a pedal and a pedal position of the pedal indicates an amount of the second torque to provide to the at least on wheel during the gear change.

3. The vehicle of claim 2, wherein the pedal is an accelerator pedal.

4. The vehicle of claim 3, wherein the interface device further comprises a clutch pedal adapted to selectively control the clutch to engage the first propulsion source to the at least one wheel.

5. The vehicle of claim 1, wherein the first propulsion source comprises a combustion engine.

6. The vehicle of claim 1, wherein the second propulsion source comprises an electric motor.

7. A vehicle comprising:
a plurality of wheels;
a clutch;
a first propulsion source connected to at least one first wheel of the plurality of wheels via the clutch, the first propulsion source adapted to provide a first torque to the at least one first wheel, the clutch adapted to selectively remove the first torque from the at least one first wheel during a gear change by disengaging the first propulsion source from the at least one first wheel;
a second propulsion source connected to at least one second wheel; and
an interface device adapted to control a provision of a second torque from the second propulsion source to the at least one second wheel during the gear change.

8. The vehicle of claim 7, further comprising mechanical reduction connecting the second propulsion source to the at least one second wheel.

9. The vehicle of claim 7, further comprising a transmission connected to the at least one first wheel and adapted to selectively engaged to the first propulsion source.

10. The vehicle of claim 9, wherein the transmission comprises a final drive connected to the at least one first wheel.

11. The vehicle of claim 10, wherein the second propulsion source is connected to the final drive.

12. A method for providing a torque to a wheel of a vehicle, comprising:
providing a first torque from a first propulsion source to the wheel;
removing the first torque to the wheel using a clutch during a gear change;
indicating a second torque to the wheel using a pedal during the gear change; and
applying the second torque from a second propulsion source to the wheel during the gear change.

13. A method for providing a torque to a first wheel and a second wheel of a vehicle, comprising:
providing a first torque from a first propulsion source to the first wheel;
removing the first torque to the first wheel using a clutch during a gear change;
indicating a second torque to the second wheel using a pedal during the gear change; and
applying the second torque from a second propulsion source to the second wheel during the gear change.
